(19) United States
(12) Patent Application Publication
(10) Pub. No.: US 2015/0045992 A1
(43) Pub. Date: Feb. 12, 2015

(54) WORK VEHICLE ROBOTIC PLATFORM

(71) Applicants: CNH Industrial America LLC, New Holland, PA (US); Autonomous Solutions, Inc., Petersboro, UT (US)

(72) Inventors: Robert D. Ashby, Collinston, UT (US); Brad A. Baillio, Smithfield, UT (US); Matthew D. Berkemeier, Logan, UT (US); John Droter, Logan, UT (US); Jeffrey L. Ferrin, Smithfield, UT (US); Mark D. Hayes, Hyde Park, UT (US); Joshua Henrie, Hyrum, UT (US); Michael G. Hornberger, Weston, ID (US); Daniel J. Morwood, Amalga, UT (US); John A. M. Petersen, Providence, UT (US); Thomas M. Petroff, Richmond, UT (US); Eric A. Poulson, Paradise, UT (US); Colton J. Schenk, Tremonton, UT (US); Devin M. Stewart, Logan, UT (US); J. Brian Stewart, Amalga, UT (US); Melvin W. Torrie, Petersboro, UT (US); Mitchel R. Torrie, Hyrum, UT (US); Bret T. Turpin, Wellsville, UT (US); Geoffrey L. Viola, Logan, UT (US)

(73) Assignees: Autonomous Solutions, Inc., Petersboro, UT (US); CNH Industrial America LLC, New Holland, PA (US)

(21) Appl. No.: 14/455,479

(22) Filed: Aug. 8, 2014

Related U.S. Application Data
(60) Provisional application No. 61/863,756, filed on Aug. 8, 2013.

(51) Int. Cl. G05D 1/02

(52) U.S. Cl. CPC G05D 1/021; G05D 1/0287
USPC 701/2; 701/23; 180/14.1; 180/15

(57) ABSTRACT

A robotic control system for a vehicle having a chassis and a drive system carrying the chassis. The robotic control system including a controller configured to control the drive system. The controller being further configured to at least one of auto-load the vehicle onto a trailer, preclude tipping of the vehicle, stabilize yaw of the vehicle, simulate Ackerman steering, balance the vehicle on two wheels, retrieve an other vehicle, transfer a payload from the vehicle to the other vehicle, coupling of at least one other vehicle to the vehicle, retrieval or movement of a container using either relative sensing or absolute position referencing, profile cutting of plants, and 3D print cement.

This is a non-provisional application based upon U.S. provisional patent application Ser. No. 61/863,756 entitled “WORK VEHICLE ROBOTIC PLATFORM”, filed Aug. 8, 2013, which is incorporated herein by reference.

### BACKGROUND OF THE INVENTION

1. Field of the Invention

The present invention relates to work vehicles, and, more particularly, to work vehicles which are controlled using a vehicle guidance control system (VGCS).

2. Description of the Related Art

Vehicles such as skid steer loaders are a mainstay of agricultural and construction work. In their most common configuration, they have two drive wheels on each side of a chassis that are driven in rotation by one or more hydraulic motors coupled to the wheels on one side and another one or more hydraulic motors coupled to the wheels on the other side.

The wheels on one side of the vehicle can be driven independently of the wheels on the other side of the vehicle. This permits the wheels on opposing sides of the vehicle to be rotated at different speeds, in opposite directions, or both. By rotating in opposite directions, the skid steer can rotate in place about a vertical axis that extends through the vehicle itself.

The vehicles often have an overall size of about 4×8′ to 7×12′ feet which, when combined with their ability to rotate in place, gives them considerable mobility at a worksite. This mobility makes them a preferred vehicle.

Skid steer vehicles have at least one loader lift arm that is pivotally coupled to the chassis of the vehicle to raise and lower at the operator's command. This arm typically has a bucket, blade, or other implement attached to the end of the arm that is lifted and lowered thereby. Perhaps most commonly, a bucket is attached to the arm and the skid steer vehicle. This bucket is commonly used to carry supplies or particulate matter such as gravel, sand, or dirt around a worksite.

Vehicles, such as the skid steer loader discussed above as well as other vehicles used in the agricultural, forestry and construction industries are typically controlled by an operator sitting at an operator station. However, it is also becoming more common for such vehicles to be controlled automatically through the use of a VGCS. With a conventional VGCS, an operator remains at the operator station so that control of the vehicle can be overtaken manually should the need arise (known as a semi-autonomous VGCS). The operator typically drives the work vehicle to a predefined area, such as an agricultural field, then actuates the VGCS so that the work vehicle can be automatically driven in a predefined path through the field. The operator also manually attaches any tools (e.g., implements), and loads any application materials (such as fertilizer, herbicides, etc.), prior to placing the work vehicle in the VGCS mode. Regardless of the application, the operator is always present and ultimately under final (over-ride) control of the work vehicle.

For semi-autonomous VGCS as described above, it is also known to provide various geospatial data to the controller onboard the vehicle such that the position of the vehicle within a geospatial framework can be determined within certain tolerances. For example, in the case of an agricultural sprayer, it is known to utilize global positioning system (GPS) data to turn on and off different sprayer boom sections as the sprayer traverses across a field. As another example, it is known to utilize GPS data to vary the application rate of fertilizer as a fertilizer spreader traverses across a field.

What is needed in the art is a true autonomous VGCS with the ability to control extended vehicle systems.

### SUMMARY OF THE INVENTION

The present invention is directed to an autonomous robotic platform in the form of a vehicle.

The present invention consists in one form thereof of a robotic control system for a vehicle having a chassis and a drive system carrying the chassis. The robotic control system including a controller configured to control the drive system. The controller being further configured to at least one of auto-load the vehicle onto a trailer, preclude tipping of the vehicle, stabilize yaw of the vehicle, simulate Ackerman steering, balance the vehicle on two wheels, retrieve an other vehicle, transfer a payload from the vehicle to the other vehicle, coupling of at least one other vehicle to the vehicle, retrieval or movement of a container using either relative sensing or absolute position referencing, profile cutting of plants, and 3D print cement.

The present invention consists in another form thereof of a robotic vehicle, including a chassis, a drive system carrying the chassis, and a robotic control system. The robotic control system including a controller configured to control the drive system. The controller being further configured to at least one of auto-load the vehicle onto a trailer, preclude tipping of the vehicle, stabilize yaw of the vehicle, simulate Ackerman steering, balance the vehicle on two wheels, retrieve an other vehicle, transfer a payload from the vehicle to the other vehicle, coupling of at least one other vehicle to the vehicle, retrieval or movement of a container using either relative sensing or absolute position referencing, profile cutting of plants, and 3D print cement.

An advantage of the present invention is that it provides a true VGCS autonomous system.

Another advantage of the present invention is that vehicles can be coupled physically and controllingly so as to effectively form a machine with enhanced capabilities.

Yet another advantage of the present invention is that the vehicles may be interchangeable, so that if two are being used together a third can replace one of the two so that one vehicle can receive maintenance or go refuel itself.

Yet another advantage of the present invention is that the autonomous action allows for repeatable three dimensional movements so that such things a 3D printing can be undertaken with the vehicle.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of an embodiment of a robotic vehicle of the present invention;

FIG. 2 is a top view of the robotic vehicle of FIG. 1;

FIG. 3 is a view of two robotic vehicles coupled together exhibiting an embodiment of the present invention;

FIG. 4 is a view of two robotic vehicles coupled together exhibiting another embodiment of the present invention;

FIG. 5 is a view of a robotic vehicle of FIG. 1 or 2 having a mobility attachment connected thereto;

FIG. 6 is a view of a robotic vehicle of FIG. 1 or 2 having an extended mobility attachment connected thereto;

FIG. 7 is a view of a control device for interfacing with at least one of the robotic vehicles of FIGS. 1-6; and

FIG. 8 is a view of a robotic vehicle, which could be from any of FIGS. 1-6 having an implement coupled thereto.

Corresponding reference characters indicate corresponding parts throughout the several views. The exemplifications set out herein illustrates embodiments of the invention, and each such exemplification is not to be construed as limiting the scope of the invention in any manner.

### DETAILED DESCRIPTION OF THE INVENTION

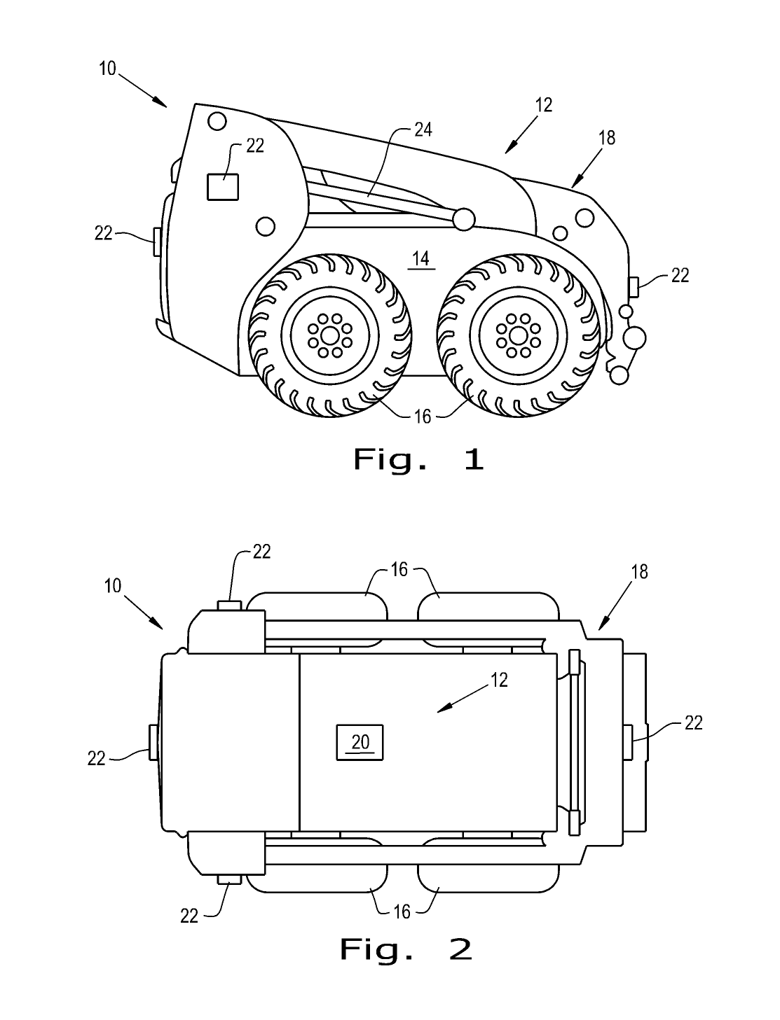

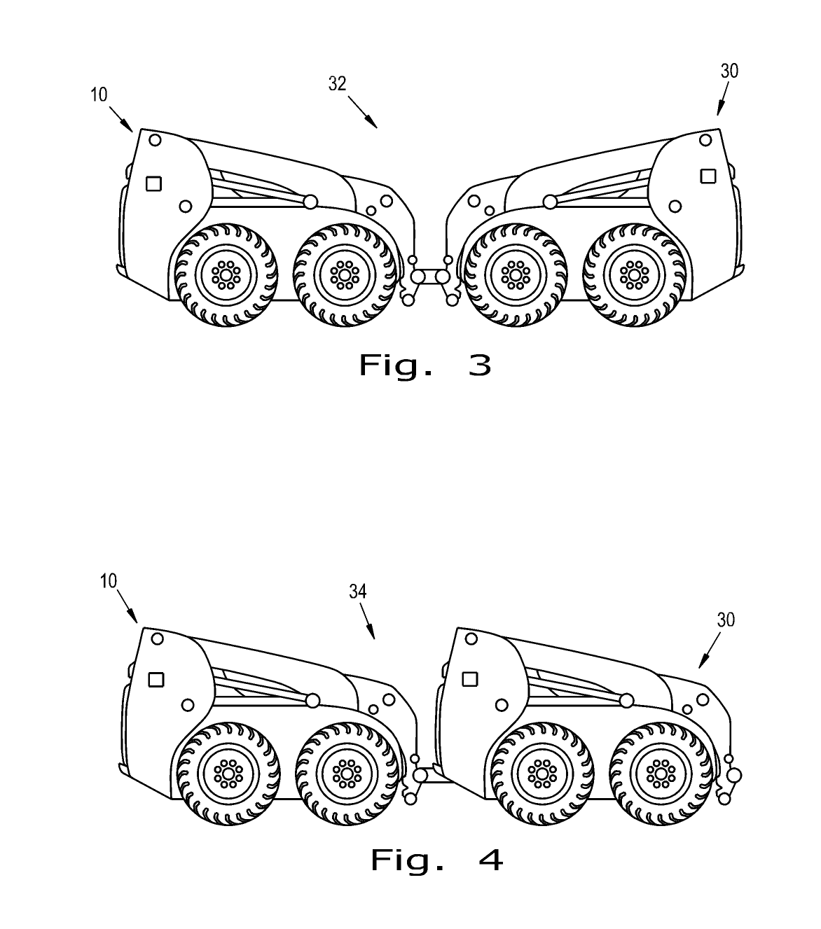

Referring now to the drawings, and more particularly to FIGS. 1 and 2, there is shown a vehicle 10 in the form of a skid steer loader 10, which has an embodiment of a control system 12 of the present invention that provides a truly autonomous work vehicle with a truly autonomous VGCS, in which an operator need not be present within the operator cab of the vehicle. Vehicle 10 additionally includes a chassis 14, ground conveyance devices 16 in the form of a drive system 16 illustrate here as wheels 16, a lift mechanism 18 is connected to chassis 14.

Adapting work vehicle 10 such as a skid steer platform to robotic control allows for remote, autonomous, semi-autonomous, and multi-vehicle cooperative operation of a proven mechanical platform. This platform provides a variety of existing implements, attachments, and accessories. Each accessory can benefit from open and closed loop robotic control adapted to its particular uses. The platform is naturally extensible and new attachments will be created to expand its applications.

Command and Control—System communications between an operator and the vehicle(s) can include: RF (radio or cellular), light, visual, subsonic, ultrasonic, and acoustics means of communications. Visual gestures and voice instructions from the human operator can also be a source of control.

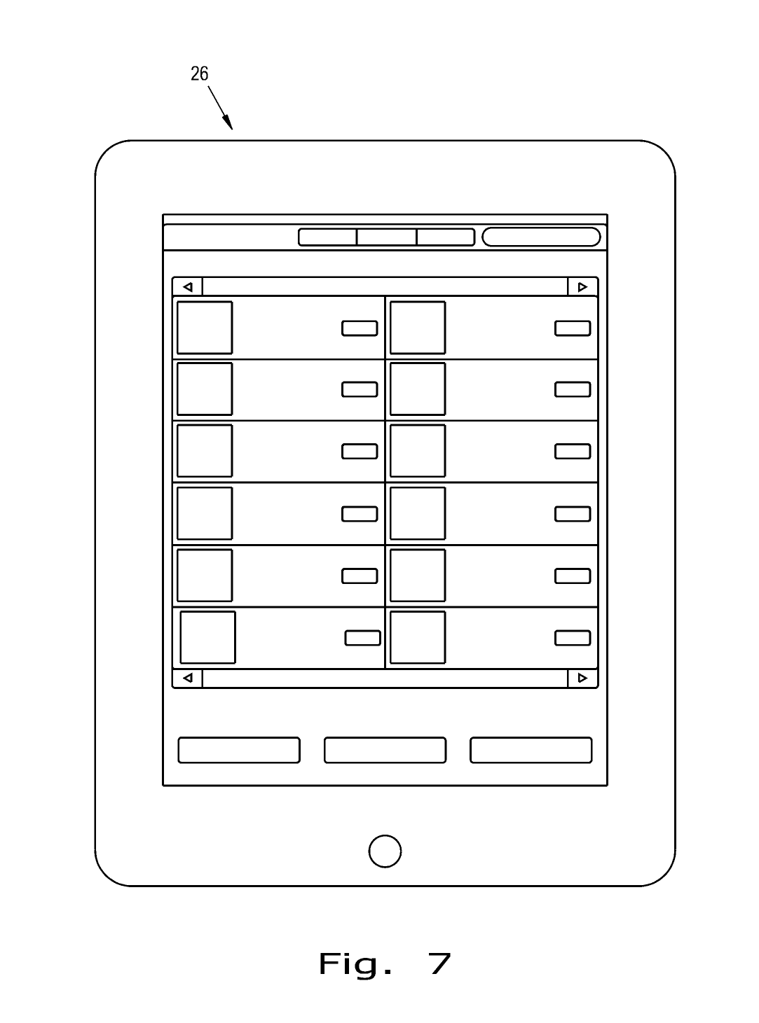

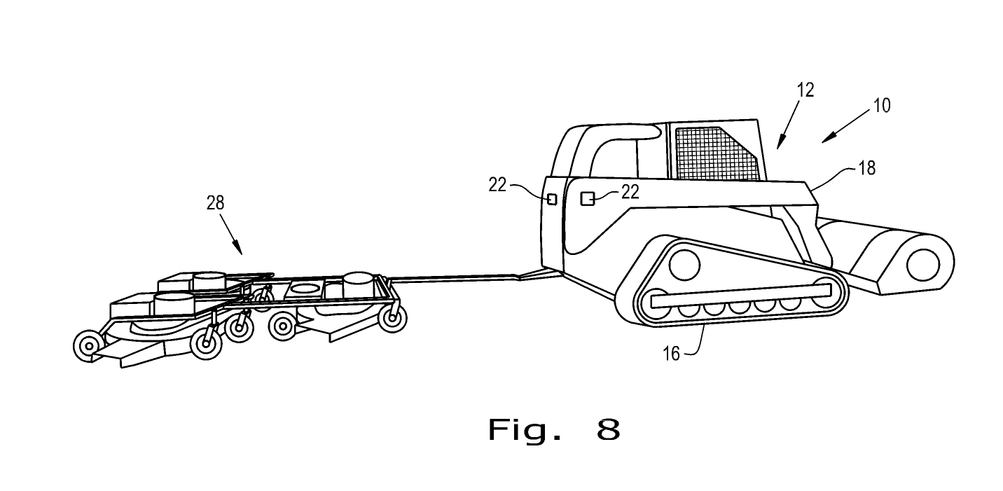

Now additionally referring to FIGS. 3-8, it is shown that the present invention utilizes the proven skid-steer platform to create a robotic platform capable of line of sight remote control, tele-operation, full autonomous, and multi-vehicle cooperative operation. This platform includes the common components of environment and situational awareness, and GPS and GPS denied positioning and control. The present invention can be applied as an aftermarket add-on or during the OEM manufacturing. The operator controls (and cab) can be left on the equipment for those that wish to have manual operation functionality in addition to the enhanced functionality of the present invention. The present invention includes:
Point and Click on command screen video/sensor feed to direct the motion of vehicle 10 and/or an implement 28, which can be done remotely by away of apps on a remote device 26 (see FIG. 7).
Train and Repeat optional functions.
Training of the system can be done via cell phone etc.
   Manual
   TeleOp programing/Remote Control 26 (RC)
   Vehicle 10 and implement 28 coordination
Portable controllers 26 can be used such as
   Existing commercial off the shelf (COTS) electronics may be incorporated.
   RC Futaba
The present invention can mirror another vehicle control while controlling or disabling your own control—Example: the operator drives a normal skid steer and either both vehicles do the same things based on his control inputs or his unit is disabled and he controls the other vehicle with those inputs.
Coupled Behavior Control—One or many vehicles can be coupled to another skid steer to provide extended functionality. This coupling can be done through physical hitches, Guideline™ Tether, or environment sensors (relative or absolute reference) can be used to create a virtual coupling. For example coupled behaviors may include jointly carrying a load, manipulating items, scanning, and painting.
   Specific example of two vehicles coupled together (FIGS. 3 and 4) with a physical hitch would have much more mobility over rough terrain and could carry, for example soldier gear into the fight like a pack mule. The coupling can be by way of lift mechanisms 18.
   Coordination of the vehicles include delays between units, offsets between units, formations of units, and team functioning of units.
   Swarming—Utilize multiple vehicles with similar or complementary attachments to solve a problem.
Physical waypoints, paths, etc. are directed through an interface such as ASI robots' Mobius.
Action tagged objects—Automatic collection/movement of bales, barrels, etc. that have been either dynamically discovered with environment sensors or tagged with absolute positioning references (such as GPS and RFID)
A command panel can be on board the vehicle—for example, a touch screen panel can be put on the rear of the vehicle for setting up and/or the scripting of actions to be carried out.
A master toy (model) interface can be incorporated—by using a similarly designed toy sized model of the slave vehicle to control its operation.
   Environment Sensing—of the control system may use at least the following:
Pan Tilt Zoom (PTZ) sensors 22 that allow a controller 20 to steer a sensor 22 based on dynamically needed coverage (for example, spinning right navigation automatically points the sensor to the right), or full 3D coverage based on increased number of sensors to cover the desired zones of travel/actuation
   Sensors can include any of the below or a fused combination of them as needed for the environment, weather, application, and vehicle/attachment speeds
      Stereo camera or non-stereo camera
      Structured Light
      Kinect of similar device
      Bumper
      Radar
      Laser/Lidar (Light Detection and Ranging)/Ladar (Laser Radar)/Flash lidar
      IR (Infrared)
      Ultrasonic/Acoustic
      Visual Light
         Vehicle Sensing—by control system 12 may use at least the following:
Hydraulic pressure of attachment, and each onboard cylinder to detect the load applied thereto, outside forces, and load distribution.
Implement and cylinder position.
RPM of the engine.
GPS/Gyro/Accelerometer, Pitch/Roll/Yaw—of both vehicle 10 and implement 28 with absolute and/or relative positioning.
Integrate agricultures ISOBUS and other RFID solutions for automatic attachment identification and corresponding capability communication.

The skid steer platform 10 allows for vehicle 10 to automatically change its configuration and attachments so as to accomplish multiple tasks without human intervention. For example, platform 10 can drill holes using a post hole tool, automatically change from the post hole tool to a bucket and fill in the holes as needed without reconfiguring the platform manually.

Sensors on the attachments can be independent of main vehicle 10 and can harvest power if needed from hydraulic fluid flow, heat, or movement. This removes the need for a human to plug in or attach components with accessories beyond what is needed for standard manned operation.

The sensors 22 of the skid-steer platform 10 can be used to determine when maintenance or repair is needed on skid-steer 10. For example, a sensor 22 on a boom position coupled with a valve control could detect a leaky valve that causes the lift boom to settle.

Functionality—of the present invention:
Auto loading of vehicle on to a trailer—Using the environment sensors the vehicle 10 autonomously drives up the ramp and positions itself on the trailer.
Antiroll (navigations and implement)—Utilizing the environmental sensors and vehicle sensors it prevents navigation and implement actuation that will result in a tip/roll over.
Yaw stabilization—for human, RC, Telelop, and Autonomous operation the vehicle sensors are used to hold course (Yaw) despite any perturbations caused by terrain, implements, or outside forces.
RPM management (fuel savings, noise temperature control)—Intelligently control the RPM to minimize fuel consumption based on the needed power for a given operation.
Traction control—minimize slippage by using vehicle 10 and environment sensors 22 to detect motion of the platform vs. the command signal and intelligently modify the speed of wheels 16. When independent wheel command is possible (electric skid steer version for example) then the present invention also provides for independent wheel speed modulation.
Quick attach automation of attachments and/or other vehicles.
Ackerman simulation—Simulate Ackerman steering given a steering angle of vehicle 10 with a focus on avoiding damage to the terrain and to minimize tire ware.
Inverted pendulum—Balance vehicle 10 on two wheels (front or back) to extend reach or change orientation of implement to facilitate a new or improved functionality.
Autorescue—When a vehicle breaks down another skid steer automatically goes to the vehicle location and couples to it and brings it back to a desired location.
Autocharge, Autofuel, Autoswap—Automatically go to a refuel, recharge, or battery swap location.
Load Transfer (offload)—An automatic transfer of a payload from one skid steer to another skid steer.
Towing—Virtual conveyor belt by coupling multiple units together with a combined carrying capacity attachment box. With the system having either a human or an unmanned leader follower configuration.
Yard Dog—Automatic retrieval/movement of trailers, pallets, barrels, etc. utilizing either relative sensing or absolute position referencing.
Trimming (trees or hedges) or more generally profile cutting—Closed loop control of cutting attachments on vehicle 10 to a desired contour (examples include: hedge trimming, ditch/road profiles, overhanging trees and landscaping).

### New Applications/Attachments

Sample Collection of crops, weeds, forestry and/or soil.
Dump truck by placing a box where the cab is on prior art vehicles.
Utilize holding tanks/reservoirs for the distribution of fluid by spraying, cement by 3D printing, cement by troweling or shaping curbing,
Fire Fighting robotic system.
3D world/object map building using environment sensors of a building or an outdoor feature.
Movie making using a steady repeatable camera motion platform.
Sculpting using a cutting or grinding attachment
The instrumented vehicle 10 can be used as an operational monitor or trainer for human operators providing a recording of their activities as well as real time feedback on their current proficiency, adherence to policy and performance enhancement.

The present invention can be used as a user assist to leverage the instrumentation of vehicle 10 for the operations of a manned vehicle 10. The present invention allows for the human element to be a part of the control to close the loop for operations such as those listed above with the human in the loop onboard the vehicle. For example, such operations as: Yaw stabilization, trailer loading and anti-collision.

The present invention includes the robotizing of the skid-steer platform 10 to allow for all the varied functions and capabilities inherent in the skid steer platform 10 currently, with the benefit of the remote and autonomous operation.

Sensors 22 can be located directly above the front of the engine compartment as shown in FIG. 1, and as needed, for example a sensor 22 can be positioned on the cross beam of the lift arms, and collision sensors on the side (mounted on the body in front or behind the wheels) and to the rear to prevent spinning, backing, or driving into obstructions.

Control system 12 in the form of automation electronics box 12 is placed inside and underneath an access panel that covers the floor where the foot pedals were located in a manned skid steer loader.

Other functionality is contemplated for incorporation into the work vehicle robotic platform 10 including:

### Environment Sensing

PTZ (Pan-Tilt-Zoom) with stereo/Kinect video overlay
   Turning of vehicle 10 in a direction of need.
   Dynamic Tracking of operations of vehicle 10.
3D coverage (single or multiple sensing units)
   Stereo on non-stereo camera
   Structured Light
   Bumper
   Radar
   Laser/Lidar/Ladar/Flash lidar
   IR
   Ultrasonic/Acoustic
   Visual Light

### Sensing

Hydraulic pressure—position
Implement Position
RPM
Tilt—both vehicle and implement
Weight of load
RFID Isobus
GPS/Gyro
Load distribution

### Command and Control

Voice Recognition
Hand signals
Point and Click
Train and Repeat
Training via cell phone etc.
   Manual
   Teleop/RC
   Vehicle and implement
Portable controller
   Existing COTS commercial electronics
   RC Futaba
Mirror of other vehicle (slave)
Human and other vehicles (voodoo doll)
Guideline, physical connection, wireless tracking, optics
Delays, offsets, formations, team
Swarming
Physical waypoint
Action tagged objects—bales, barrels
High level operations
Command panel on board
Master toy (model) interface to control the slave full size vehicle

### Communication Methods

Wifi
Cellular
Optical

### Functionality

Auto loading of vehicle on trailer
Antiroll (navigations and implement)
Yaw stabilization
RPM management (fuel savings, noise temperature control)
Traction control
Quick attach automation
Ackerman simulation (specify turning radius)
Inverted pendulum (balance on two wheels to extend reach or lift
Sample Collection of crops/forestry/soil
Dump truck
Tanks—cement, fluid
3D printing
Fire Fighting
Sculpting
Autorescue
Coupled Behavior
Autocharge
Autoswap
Autofuel
Docking
Load Transfer (offload)
Towing self propelled
Yard Dog
Trimming (trees hedges) Profile cutting
Slave other vehicle disabling your own
Hollywood steady repeatable camera platform

Additionally, the present invention includes the coupling of two (or more) work vehicles together physically in a variety of ways for extreme mobility. The coupling also may include the consolidation of control so that the newly formed (coupled) machine will operate as a single machine with one set of controls and with new sets of limitations and attributes. This consolidation may, for example, result in a machine having an ability to climb higher obstacles. This new capability is then part of the consolidated limits of machine 10. It is possible to hook vehicle 10 face-to-face with vehicle 30, as shown in FIG. 3, via a ball joint mounted on the quick coupling plates of vehicles 10 and 30, thereby forming a consolidated machine 32. This coupled arrangement may have speed differences between the vehicles and would enable them to lift each other up over terrain. Vehicles 10 and 30 can also be coupled front-to-back, as shown in FIG. 4, to provide other characteristics in the form of a machine 34. Although vehicles 10 and 30 are illustrated as being substantially similar, it is also contemplated that the vehicles can be different.

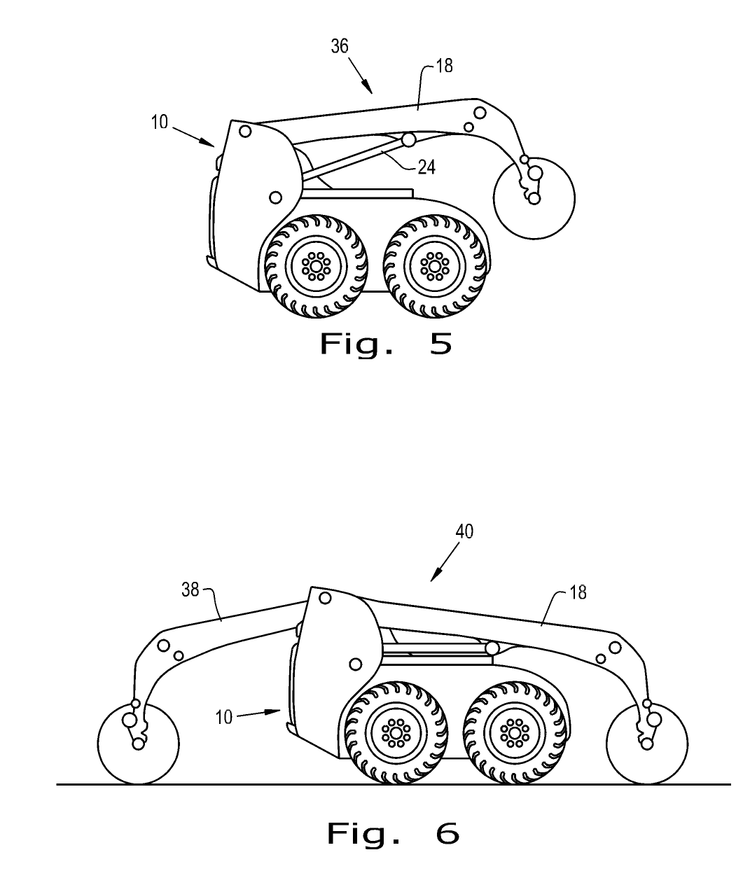

Another extreme terrain option is to put a two wheel attachment on the quick coupler of vehicle 10, as shown in FIG. 5, to create a 6 wheel vehicle 36 that can lift the front wheels to clear obstacles. As shown in FIG. 6 a linkage 38 could also be extended to the back of vehicle 10 to have another two wheels attached resulting in an 8 wheel vehicle 40. Now when the front wheels are lifted the rear vehicles lower for better stability in traversing extreme steps or gaps in the terrain.

Vehicle 10 can have an implement 26 such as a mower 26 coupled thereto for automated completion of a task such as mowing. It is also contemplated that a machine 34 could be used to pull an implement 26 that required more power than vehicle 10 alone would be able to effectively deliver. It is also contemplated that vehicle 10 and vehicle 30 could be separately coupled to an implement 26 and the consolidated control of the present invention would allow implement 26/vehicle 10/vehicle 30 to be used in a coordinated manner.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A robotic vehicle, comprising:
a chassis;
a drive system carrying said chassis; and
a controller configured to control said drive system, said controller being further configured to at least one of auto-load the vehicle onto a trailer, preclude tipping of the vehicle, stabilize yaw of the vehicle, simulate Ackerman steering, balance the vehicle on two wheels, retrieve an other vehicle, transfer a payload from the vehicle to the other vehicle, coupling of at least one other vehicle to the vehicle, retrieval or movement of a container using either relative sensing or absolute position referencing, profile cutting of plants, and 3D print cement.

2. The robotic vehicle of claim 1, wherein said controller of the vehicle is configured to one of control the other vehicle and control both the vehicle and the other vehicle.

3. The robotic vehicle of claim 2, wherein said control is a consolidated control of the vehicle and the other vehicle.

4. The robotic vehicle of claim 3, wherein the vehicle and the other vehicle are physically coupled together.

5. The robotic vehicle of claim 4, further comprising a lift mechanism coupled to said chassis, the vehicle and the other vehicle being physically couplable together by way of said lift mechanism.

6. The robotic vehicle of claim 5, wherein the other vehicle also has a lift mechanism, said lift mechanism of the vehicle being physically couplable to the lift mechanism of the other vehicle.

7. The robotic vehicle of claim 1, further comprising:
at least one lift mechanism coupled to said chassis; and
at least one mobility enhancing device coupled to said lift mechanism, said mobility enhancing device being configured to contact the ground and thereby extend the types of terrain the vehicle can traverse.

8. The robotic vehicle of claim 7, wherein said mobility enhancing device is positioned in a fore direction of travel of the vehicle.

9. The robotic vehicle of claim 7, wherein said at least one mobility enhancing device includes a first mobility enhancing device and a second mobility enhancing device, said first mobility enhancing device being positioned in a fore direction of travel of the vehicle, said second mobility enhancing device being positioned in an aft direction of travel of the vehicle.

10. The robotic vehicle of claim 1, wherein said controller is configured to at least one of simulate Ackerman steering, balance the vehicle on two wheels, coupling of at least one other vehicle to the vehicle, profile cutting of plants, and 3D print cement.

11. The robotic vehicle of claim 1, further comprising a remote control application executable on a general purpose communication device, said remote control application being configured to communicate with said controller to thereby control the vehicle using said application.

12. The robotic vehicle of claim 1, wherein the robotic vehicle is a skid steer loader.

13. A robotic control system for a vehicle having a chassis and a drive system carrying the chassis, the system comprising:
a controller configured to control the drive system, said controller being further configured to at least one of auto-load the vehicle onto a trailer, preclude tipping of the vehicle, stabilize yaw of the vehicle, simulate Ackerman steering, balance the vehicle on two wheels, retrieve an other vehicle, transfer a payload from the vehicle to the other vehicle, coupling of at least one other vehicle to the vehicle, retrieval or movement of a container using either relative sensing or absolute position referencing, profile cutting of plants, and 3D print cement.

14. The robotic control system of claim 13, wherein said controller of the vehicle is configured to one of control the other vehicle and control both the vehicle and the other vehicle.

15. The robotic control system of claim 14, wherein said control is a consolidated control of the vehicle and the other vehicle.

16. The robotic control system of claim 15, wherein the vehicle and the other vehicle are physically coupled together.

17. The robotic control system of claim 16, wherein the vehicle additionally has a lift mechanism coupled to the chassis, the vehicle and the other vehicle being physically couplable together by way of the lift mechanism.

18. The robotic control system of claim 17, wherein the other vehicle also has a lift mechanism, the lift mechanism of the vehicle being physically couplable to the lift mechanism of the other vehicle.

19. The robotic control system of claim 13, wherein the vehicle additionally includes:
at least one lift mechanism coupled to the chassis; and
at least one mobility enhancing device coupled to the lift mechanism, the mobility enhancing device being configured to contact the ground and thereby extend the types of terrain the vehicle can traverse.

20. The robotic control system of claim 19, wherein the mobility enhancing device is positioned in a fore direction of travel of the vehicle.

21. The robotic control system of claim 19, wherein said at least one mobility enhancing device includes a first mobility enhancing device and a second mobility enhancing device, said first mobility enhancing device being positioned in a fore direction of travel of the vehicle, said second mobility enhancing device being positioned in an aft direction of travel of the vehicle.

22. The robotic control system of claim 13, wherein said controller is configured to at least one of simulate Ackerman steering, balance the vehicle on two wheels, coupling of at least one other vehicle to the vehicle, profile cutting of plants, and 3D print cement.

23. The robotic control system of claim 13, further comprising a remote control application executable on a general purpose communication device, said remote control application being configured to communicate with said controller to thereby control the vehicle using said application.

24. The robotic control system of claim 13, wherein the vehicle is a skid steer loader.
